(19) United States
(12) Patent Application Publication
(10) Pub. No.: US 2026/0223050 A1
(43) Pub. Date: Jul. 30, 2026

(54) Sidelink Control and Synchronization Reference Signaling for SL PRS Transmission

(71) Applicant: Apple Inc., Cupertino, CA (US)

(72) Inventors: Oghenekome Oteri, San Diego, CA (US); Ankit Bhamri, Haar (DE); Dawei Zhang, Saratoga, CA (US); Wei Zeng, Saratoga, CA (US); Chunhai Yao, Beijing (CN); Chunxuan Ye, San Diego, CA (US); Seyed Ali Akbar Fakoorian, San Diego, CA (US); Haitong Sun, Saratoga, CA (US); Hong He, San Jose, CA (US)

(21) Appl. No.: 19/146,656

(22) PCT Filed: Feb. 16, 2023
(86) PCT No.: PCT/CN2023/076512

§ 371 Date: Jul. 9, 2025

(51) Int. Cl. H04W 64/00; H04W 92/18

(52) U.S. Cl. CPC H04W 64/00; H04W 92/18

(57) ABSTRACT

Apparatuses, systems, and methods for sidelink control and synchronization reference signaling for SL PRS transmission, e.g., in 5G NR systems and beyond. A user equipment device (UE) may determine priority information associated with synchronization sources for one or more candidate anchor devices. The UE may rank, based, at least in part, on whether the sidelink positioning procedure is network-based or Global Network Satellite System (GNSS) based, the one or more candidate anchor devices using the priority information. Further, the UE may select, based, at least in part, on the ranking, one or more candidate devices to be used in the sidelink positioning procedure.

### FIELD

The invention relates to wireless communications, and more particularly to apparatuses, systems, and methods for sidelink control and synchronization reference signaling for sidelink (SL) positioning reference signal (PRS) transmission, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for sidelink control and synchronization reference signaling for SL PRS transmission, e.g., in 5G NR systems and beyond.

For example, in some embodiments, a UE may decode and/or determine priority information associated with synchronization sources for one or more candidate anchor devices. The UE may rank, grade, order, classify, sort, arrange, organize, and/or categorize, based, at least in part, on whether the sidelink positioning procedure is network-based or Global Network Satellite System (GNSS) based, the one or more candidate anchor devices using the priority information. Further, the UE may select, based, at least in part, on the ranking, prioritizing, grading, ordering, classifying, sorting, arranging, organizing, and/or categorizing, one or more candidate devices to be used in the sidelink positioning procedure.

As another example, in some embodiments, a UE may decode and/or determine priority information associated with synchronization sources for one or more candidate anchor devices. The UE may send, to a location management function (LMF), feedback regarding sidelink priority signaling, e.g., as assistance information. Further, the UE may receive, from the LMF, an indication of one or more selected anchor devices to be used in the sidelink positioning procedure. In some instances, the one or more selected anchor devices may be selected, based, at least in part, on whether the sidelink positioning procedure is network-based or GNSS-based.

As a yet further example, in some embodiments, an LMF may receive, from a UE, feedback regarding sidelink priority signaling, e.g., as assistance information. The LMF may rank, grade, order, classify, sort, arrange, organize, and/or categorize, based, at least in part, on whether the sidelink positioning procedure is network-based or GNSS-based, one or more candidate anchor devices using the priority information. Further, the LMF may select based, at least in part, on the ranking, prioritizing, grading, ordering, classifying, sorting, arranging, organizing, and/or categorizing, one or more candidate devices to be used in the sidelink positioning procedure and indicate, to the UE, the selected one or more candidate devices to be used in the sidelink positioning procedure.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments.

FIG. 2 illustrates an example block diagram of a base station, according to some embodiments.

FIG. 3 illustrates an example block diagram of a server, according to some embodiments.

FIG. 4 illustrates an example block diagram of a UE, according to some embodiments.

FIG. 5 illustrates an example of a 5G network architecture that incorporates both dual 3GPP (e.g., LTE and 5G NR) access and non-3GPP access to the 5G CN, according to some embodiments.

FIG. 6 illustrates an example of a level indication table for GNSS-based synchronization for a sidelink positioning procedure, according to some embodiments.

FIG. 7 illustrates an example of a level indication table for network-based synchronization for a sidelink positioning procedure, according to some embodiments.

FIGS. 8A and 8B illustrate block diagrams of examples of methods for selection of UE anchors for a sidelink positioning procedure, according to some embodiments.

FIG. 9 illustrates an example of positioning SCI fields for a single stage SCI, according to some embodiments.

FIG. 10 illustrates an example of a single stage SCI indicating a sidelink PRS, according to some embodiments.

FIG. 11 illustrates an example of a second stage SCI indicating a PSSCH and a sidelink PRS, according to some embodiments.

FIG. 12 illustrates an example of positioning SCI fields for a second stage SCI, according to some embodiments.

FIGS. 13, 14, and 15 illustrate block diagrams of examples of methods for selecting anchor devices for a sidelink positioning procedure, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
PDCCH: Physical Downlink Control Channel.
PDSCH: Physical Downlink Shared Channel
RRC: Radio Resource Control

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

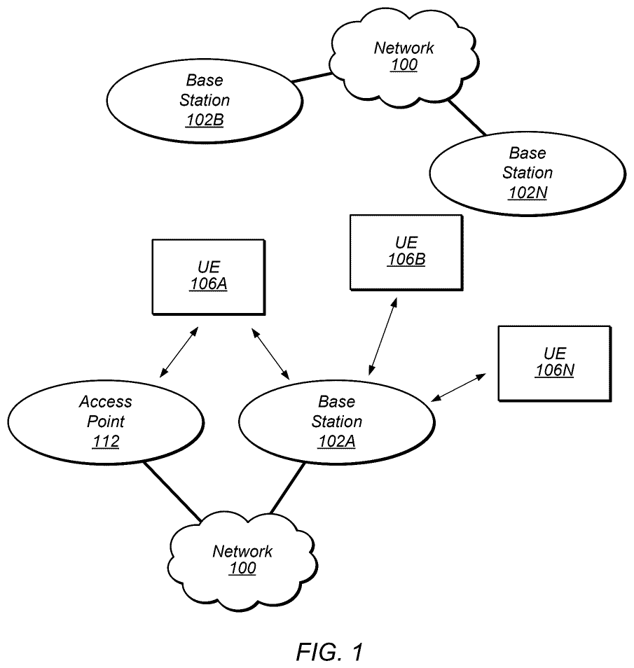

### FIG. 1: Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

In addition, the UE 106 may be in communication with an access point 112, e.g., using a wireless networking (e.g., Wi-Fi) and/or peer-to-peer wireless communication protocol (e.g., Bluetooth, Wi-Fi peer-to-peer, etc.). The access point 112 may provide a connection to the network 100.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

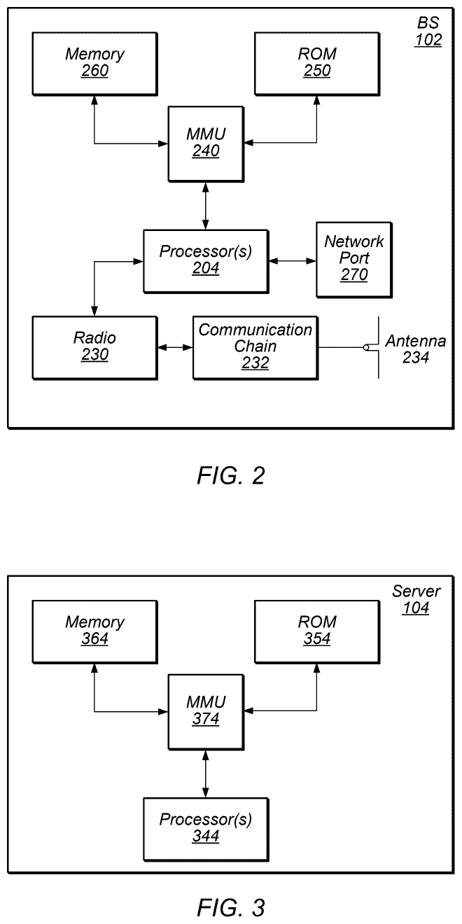

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

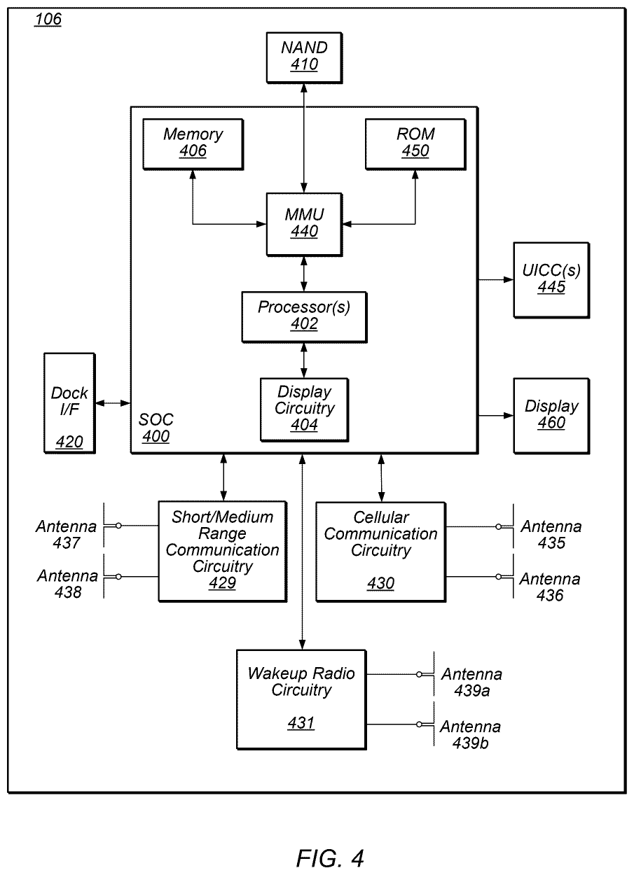

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., short to medium range wireless communication circuitry 429 (e.g., Bluetooth™ and WLAN circuitry), and wakeup radio circuitry 431. In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The wakeup radio circuitry 431may also couple (e.g., communicatively; directly or indirectly) to one or more antennas, such as antennas 439a and 439b as shown. Alternatively, the wakeup radio circuitry 431may couple (e.g., communicatively; directly or indirectly) to the antennas 435 and 436 in addition to, or instead of, coupling (e.g., communicatively; directly or indirectly) to the antennas 439a and 439b. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration. The wakeup radio circuitry 431 may include a wakeup receiver, e.g., wakeup radio circuitry 431 may be a wakeup receiver. In some instances, wakeup radio circuitry 431 may be a low power and/or ultra-low power wakeup receiver. In some instances, wakeup radio circuitry may only be powered/active when cellular communication circuitry 430 and/or the short to medium range wireless communication circuitry 429 are in a sleep/no power/inactive state. In some instances, wakeup radio circuitry 431 may monitor (e.g., periodically) a specific frequency/channel for a wakeup signal. Receipt of the wakeup signal may trigger the wakeup radio circuitry 431 to notify (e.g., directly and/or indirectly) cellular communication circuitry 430 to enter a powered/active state.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”).

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for revocation and/or modification of user consent in MEC, e.g., in 5G NR systems and beyond, as further described herein. For example, the communication device 106 may be configured to perform methods for CORESET #0 configuration, SSB/CORESET #0 multiplexing pattern 1 for mixed SCS, time-domain ROs determination for 480 kHz/960 KHz SCSs, and RA-RNTI determination for 480 kHz/960 kHz SCSs.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

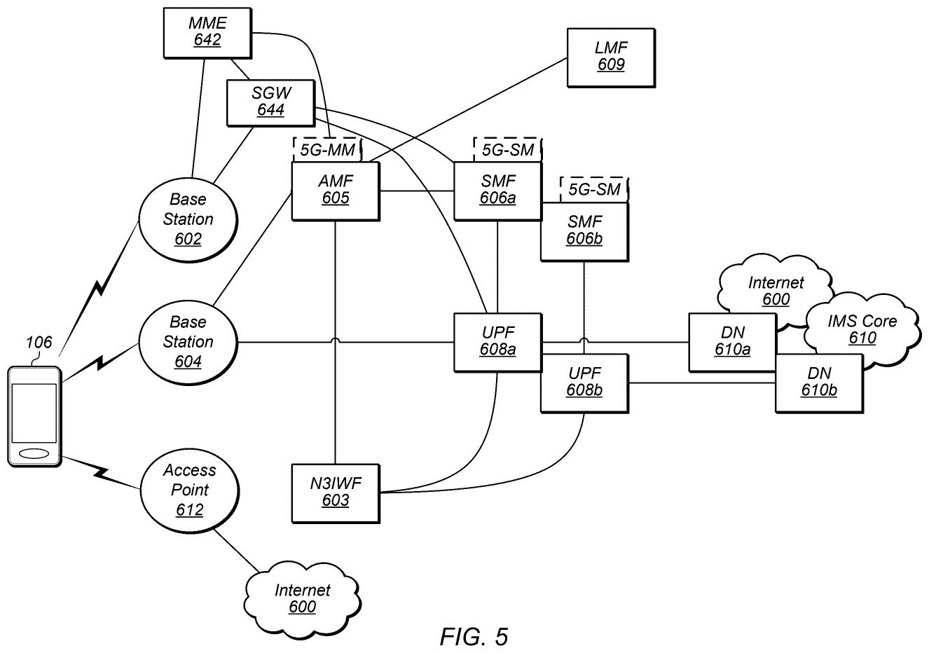

FIG. 5: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 5 illustrates an example of a 5G network architecture that incorporates both dual 3GPP (e.g., cellular access via LTE and 5G-NR) and non-3GPP (e.g., non-cellular) access to the 5G CN, according to some embodiments. As shown, a user equipment device (e.g., such as UE 106) may access the 5G CN through both a radio access network (RAN, e.g., such as gNB 604 or eNB 602, each of which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

Note that in various embodiments, one or more of the above-described entities may be configured to perform methods for sidelink control and synchronization reference signaling for SL PRS transmission, e.g., in 5G NR systems and beyond, e.g., as further described herein.

### Sidelink Control and Synchronization Reference Signaling for SL PRS Transmission

In current implementations, methods for sidelink positioning in cellular systems, e.g., such as NR cellular systems have not been defined and/or agreed upon. However, it has been agreed upon to study sidelink reference signals for positioning purposes from physical layer perspective, including signal design, resource allocation, measurements, associated procedures, and so forth reusing existing reference signals, procedures, and so forth from sidelink communication and from positioning as much as possible. Various issues have been identified as part of this study, including, for a specific target UE using a timing-based positioning method, how can the UE identify and prioritize assisting UEs that have the same synchronization reference, for sidelink signaling of a reservation/indication of sidelink positioning reference signal (PRS) resource(s) for dedicated resource pool and shared resource pool (if supported) for positioning, whether an SCI used for reserving/indicating one or more sidelink PRS resources can be a single stage SCI and/or a two stage SCI, as well as for scenarios in which a UE is in an exceptional resource pool, how does the UE perform SL positioning.

In some implementations, a UE may classify a synchronization reference (SyncRef) UE based on a sidelink synchronization signal (SLSS) identifier (ID) and a coverage indicator index (e.g., IIc). Note that a SyncRef UE may be a peer UE in range of the UE that the UE relies upon for synchronization timing. In other words, the UE may align its internal clock based on timing information received from the SyncRef UE. For example, based on the SLSS ID and coverage indicator index, SyncRef UEs may be classified into five groups with different priorities. As shown below in Table 1, a first group, G1, may include SyncRef UEs directly synchronized to a Global Navigation Satellite System (GNSS), a second group, G2, may include SyncRef UEs that are out of coverage of a GNSS or a network and are synchronized to a SyncRef UE from G1, a third group, G3, may include SynchRef UEs directly synchronized to a network, a fourth group, G4, may include SynchRef UEs that are out of coverage of a GNSS or a network and are synchronized to a SyncRef UE from G3, and a fifth group, G5, that are out of coverage of a GNSS or a network and are internally synchronized or synchronized to a SyncRef UE from G2 or G5. Then, based on the grouping of the SyncRef UEs, the UE can select a synchronization

TABLE 1
SyncRef UE Groupings

| | I_{IC} | SLSS ID | Synced To: |
|---|---|---|---|
| G1 | 1 | 0 | GNSS |
| G2 | 0 | 0 | G1 |
| G3 | 1 | 1, . . . , 335 | Network |
| G4 | 0 | 1, . . . , 335 | G3 |
| G5 | 0 | 336, . . . , 671 | Internal, G2, G5 |

reference based on the priorities as defined below in Table 2. As shown, priority levels for SyncRef UE groups may be dependent on a type of synchronization. For example, for GNSS-based synchronization, G1 SyncRef UEs may have a higher priority level than G3 SyncRef UEs, however, for network-based synchronization, G3 SyncRef UEs may have a higher priority level than G1 SyncRef UEs. However, as indicated above, an issue may arise when, for a specific target UE using a timing-based positioning method, how does a UE identify and prioritize assisting UEs that have the same synchronization reference (e.g., same priority level.

TABLE 2
SyncRef UE Priority Level

| Priority | GNSS-based | Network-based |
|---|---|---|
| Level | Synchronization | Synchronization |
| 1 | GNSS | Network |
| 2 | G1 (SyncRef UE with I_{IC} = | G3 (SyncRef UE with I_{IC} = |
| | 1 and SLSS ID = {0}) | 1 and SLSS ID = {1, . . . , |
| | | 335}) |
| 3 | G2 (SyncRef UE with I_{IC} = | G4 (SyncRef UE with I_{IC} = |
| | 0 and SLSS ID = {0}) | 0 and SLSS ID = {1, . . . , |
| | | 335}) |
| 4 | Network | GNSS |
| 5 | G3 (SyncRef UE with I_{IC} = | G1 (SyncRef UE with I_{IC} = |
| | 1 and SLSS ID = {1, . . . , | 1 and SLSS ID = {0}) |
| | 335}) | |
| 6 | G4 (SyncRef UE with I_{IC} = | G2 (SyncRef UE with I_{IC} = |
| | 0 and SLSS ID = {1, . . . , | 0 and SLSS ID = {0}) |
| | 335}) | |
| 7 | G5 (SyncRef UE with I_{IC} = | G5 (SyncRef UE with _{IC} = |
| | 1 and SLSS ID = {336, . . . , | 1 and SLSS ID = {336, . . . , |
| | 671}) | 671}) |
| 8 | G5 (internal clock) | G5 (internal clock) |

In addition, as indicated above, SCI design with regards to sidelink signaling of a reservation/indication of sidelink PRS resource(s) for dedicated resource pool and shared resource pool (if supported) for positioning has not been determined. In particular, whether a single stage SCI or a two stage SCI is needed (and corresponding designs) has not been determined.

Further, there are exceptional resource pools configured to a UE in its serving cell's broadcast or in dedicated signaling. The exceptional resource pools can be used during RLF in some cases, handover, transition from RRC IDLE to RRC CONNECTED, or during change of dedicated V2X sidelink resource pools within a cell. In these cases, a UE may not have a stable configuration of transmit resource pools may nevertheless should not be removed from the V2X system, so the UE can randomly select resources in the exceptional pool and use them temporarily. Likewise, UEs need to monitor the exceptional transmit pools for PSCCH transmissions. However, for scenarios in which the UE is in the exceptional resource pool, it is undetermined how the UE may perform sidelink positioning.

Embodiments described herein provide systems, methods, and mechanisms for sidelink control and synchronization reference signaling for SL PRS transmission, including systems, methods, mechanisms for GNSS-based synchronization priority and signaling, network-based synchronization priority and signaling, a priority procedure, an SCI for dedicated and shared resource pools, a single stage SCI design for PRS, a 2-stage SCI design for PRS, and SL positioning in an Exceptional Resource Pool. For example, in some embodiments, a UE may select assisting UEs to ensure that the assisting UEs have a common synchronization reference and have a synchronization reference that is the most accurate give a current set of conditions. As another example, for a dedicated resource pool, a single stage SCI may be used as there is no need to indicate additional information, however, for a shared resource pool (and/or in cases in which a two stage SCI is used for a dedicated resource pool), a two stage SCI may be used to indicate required information. In such instances, the second stage may indicate sidelink PRS specific information to enable backwards compatibility with existing designs. As a further example, when using an Exceptional Resource Pool, a UE may disable positioning until normal connection is re-established and/or the UE may use a shared resource pool between PSSCH and sidelink PRS to support sidelink UE positioning (note that is such instances, UE positioning requirements may be relaxed).

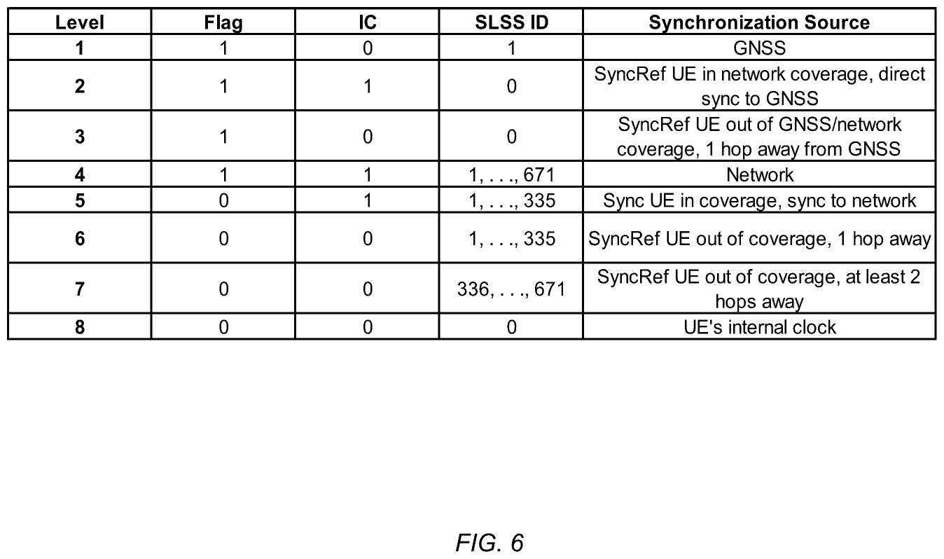

In some instances, e.g., such as for GNSS-based synchronization, a UE, such as UE 106, may use a level indication table as illustrated by FIG. 6 to selection a synchronization reference as close to a GNSS as possible. As shown, the UE may use a flag used to indicate an index of a level, an in coverage/out of coverage flag (e.g., IIc and/or IC), and an SLSS ID to determine a priority level of the synchronization reference. In some instances, the flag used to indicate the index of the level (e.g., a parameter) may be signaled to the UE as part of a positioning procedure. In some instances, the parameter may be included in an SCI as an additional synchronization indicator, in a PC5-RRC message, and/or as part of positioning protocol assistance information in one of an LTE positioning protocol (LPP) message, an NR positioning protocol A (NRPPa) message, and/or a sidelink positioning protocol (SL-PP) message. In some instances, a priority of the levels illustrated by FIG. 6 may be based on hops to a stable synchronization reference, e.g., level 1, level 4, level 2, level 5, level 3, level 6, and level 7. In some instances, a priority of the levels illustrated by FIG. 6 may be based on a preference of GNSS synchronization over network synchronization, e.g., level 1, level 2, level 4, level 5, level 3, level 6, and level 7. In some instances, level 8 may not be used and/or may not be allowed.

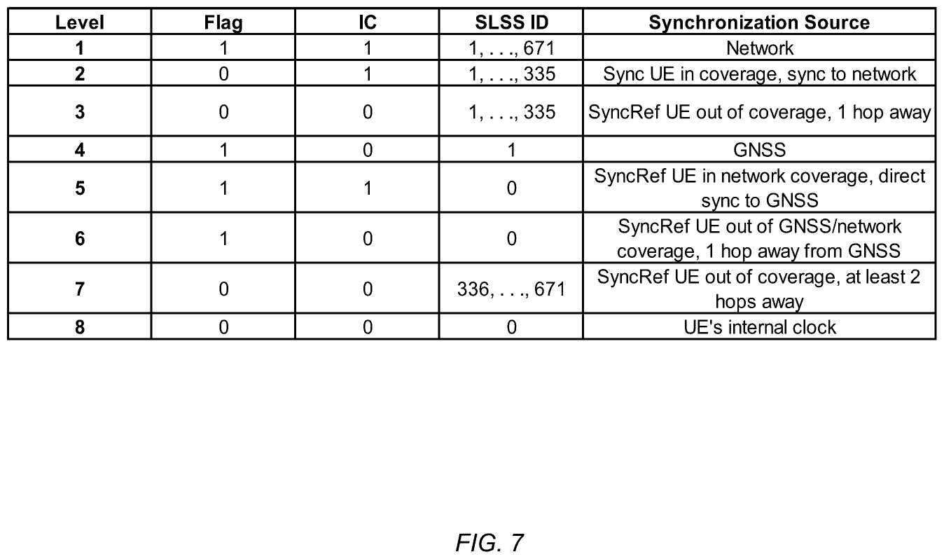

In some instances, e.g., such as for network-based synchronization, a UE, such as UE 106, may use a priority table as illustrated by FIG. 7 to selection a synchronization reference as close to a network (e.g., base station, such as base station 102) as possible. As shown, the UE may use a flag used to indicate an index of a level, a in coverage/out of coverage flag (e.g., IIc and/or IC), and an SLSS ID to determine a priority level of the synchronization reference. In some instances, the flag used to indicate the index of the level (e.g., a parameter) may be signaled to the UE as part of a positioning procedure. In some instances, the parameter may be included in an SCI as an additional synchronization indicator, in a PC5-RRC message, and/or as part of positioning protocol assistance information in one of an LTE positioning protocol (LPP) message, an NR positioning protocol A (NRPPa) message, and/or a sidelink positioning protocol (SL-PP) message. In some instances, a priority of the levels illustrated by FIG. 7 may be based on hops to a stable synchronization reference, e.g., level 1, level 4, level 2, level 5, level 3, level 6, and level 7. In some instances, a priority of the levels illustrated by FIG. 7 may be based on a preference of network synchronization over GNSS synchronization, e.g., level 1, level 2, level 4, level 5, level 3, level 6, and level 7. In some instances, level 8 may not be used and/or may not be allowed.

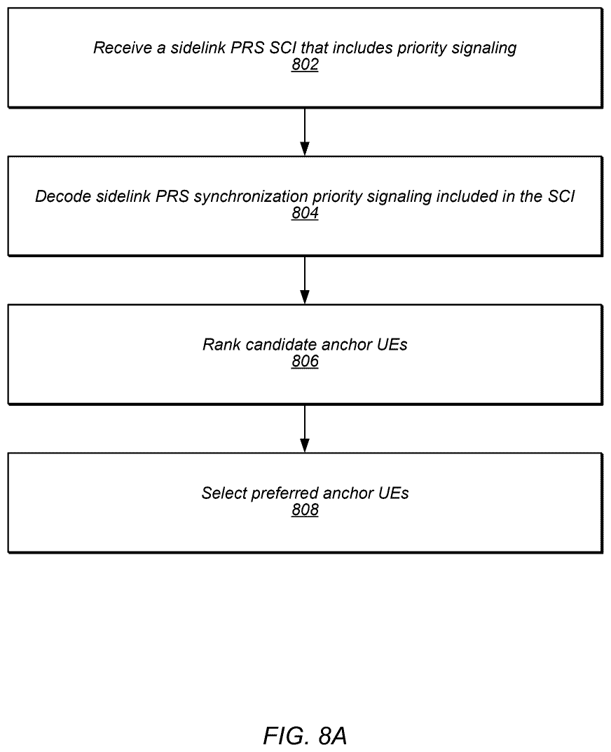

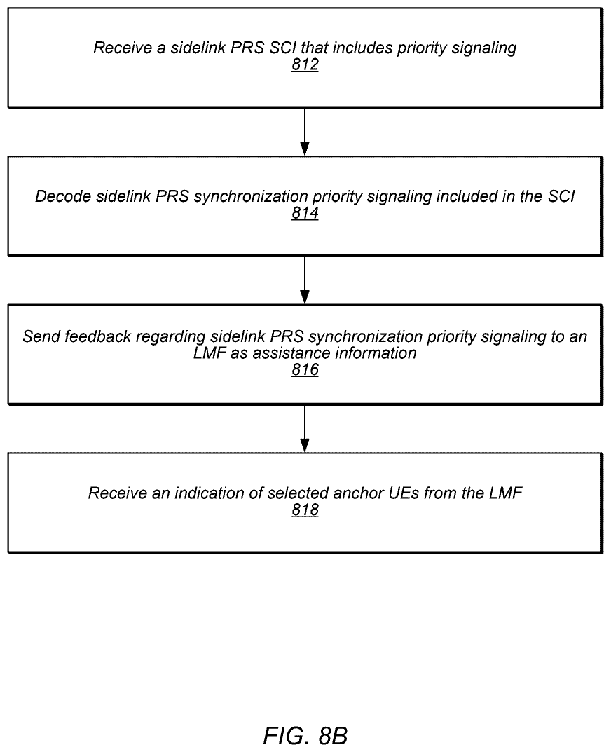

FIGS. 8A and 8B illustrate block diagrams of examples of methods for selection of UE anchors for a sidelink positioning procedure, according to some embodiments. The methods shown in FIGS. 8A and 8B may be used in conjunction with any of the systems, methods, or devices shown in the Figures, among other devices. In various embodiments, some of the method elements shown may be performed concurrently, in a different order than shown, or may be omitted. Additional method elements may also be performed as desired. Turning to FIG. 8A, as shown, this method may operate as follows.

At 802, a UE, such as UE 106, may receive a sidelink PRS sidelink control information (SCI) that may include priority signaling, e.g., such as priority information as illustrated by FIGS. 6 and 7.

At 804, the UE may decode and/or determine sidelink PRS synchronization priority signaling included in the SCI. Note that the sidelink PRS synchronization priority signaling may be included in a stage 1 SCI and/or a stage 2 SCI.

At 806, the UE may rank, prioritize, grade, order, classify, sort, arrange, organize, and/or categorize, e.g., based on a number of hops to a stable synchronization reference, a preference for GNSS-based synchronization, and/or a preference for network-based synchronization, candidate anchor UEs. Note that the ranking, prioritizing, grading, ordering, classifying, sorting, arranging, organizing, and/or categorizing may be dependent upon whether the UE is performing GNSS-based synchronization or network-based synchronization.

At 808, the UE may select preferred anchor UEs (e.g., UEs to be used in a sidelink positioning procedure) based on a number of UEs in the same level as determined by the tables illustrated in FIGS. 6 and 7.

Turning to FIG. 8B, as shown, this method may operate as follows.

At 812, a UE, such as UE 106, may receive a sidelink PRS sidelink control information (SCI) that may include priority signaling, e.g., such as priority information as illustrated by FIGS. 6 and 7.

At 814, the UE may decode and/or determine sidelink PRS synchronization priority signaling included in the SCI. Note that the sidelink PRS synchronization priority signaling may be included in a stage 1 SCI and/or a stage 2 SCI.

At 816, the UE may send feedback regarding sidelink priority signaling to a location management function (LMF), such as LMF 609, as assistance information.

At 818, the UE may receive, from the LMF, an indication of selected anchor UEs. In other words, the LMF may perform ranking, prioritizing, grading, ordering, classifying, sorting, arranging, organizing, and/or categorizing of candidate anchor UEs based on the priority signaling (e.g., based on priority information as illustrated by FIGS. 6 and 7) and select anchor UEs for the UE, e.g., based on a number of UEs in the same level as determined by the tables illustrated in FIGS. 6 and 7.

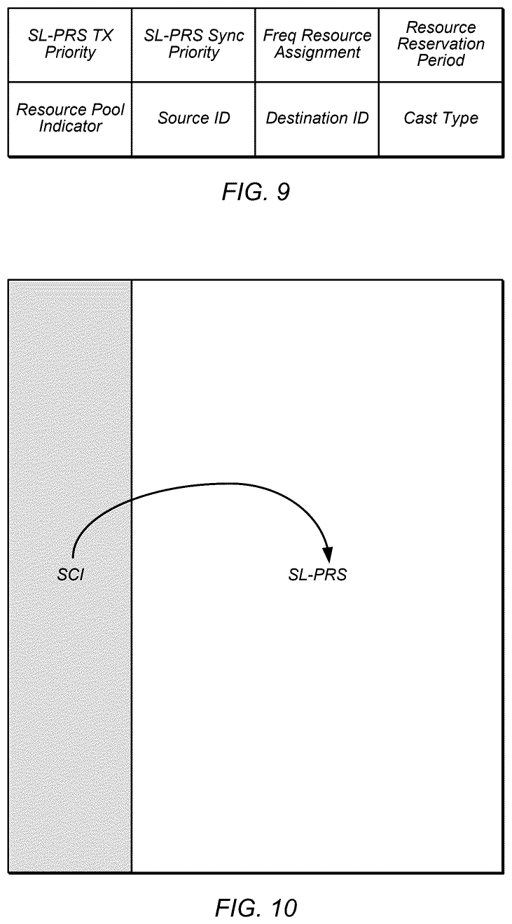

In some instances, for a dedicated resource pool, a single stage SCI may be used to reserve and/or indicate one or more sidelink PRS resources. In such instances, as illustrated by FIG. 9, positioning SCI fields may include a field indicating priority of a sidelink PRS transmission, a field indicating priority of a sidelink PRS synchronization, a frequency resource assignment in sub-channels, a time resource assignment, a resource reservation period, a shared/dedicated resource pool indicator (including a PSFCH overhead indicator and/or a PSSCH overhead indicator), a source ID (e.g., identity of a transmitting UE), a destination ID (e.g., identity of a receiving UE and/or identities of receiving UEs), and/or a cast type indicator (e.g., broadcast, unicast, and/or groupcast). In some instances, the time resource assignment may be in symbols, e.g., may indicate a start symbol and a length (in symbols) of the time resource assignment. In some instances, the time resource assignment may indicate a start symbol and a length (in symbols) may be implicit, e.g., may be based on a sidelink PRS configuration (e.g., a number of symbols of the sidelink PRS). In some instances, the cast type may be indicated by an S/D ID. In some instances, a physical layer may indicate a sidelink PRS configuration and higher layers may control whether cast type is unicast, groupcast, and/or broadcast. FIG. 10 illustrates a single stage SCI indicating a sidelink PRS, according to some embodiments.

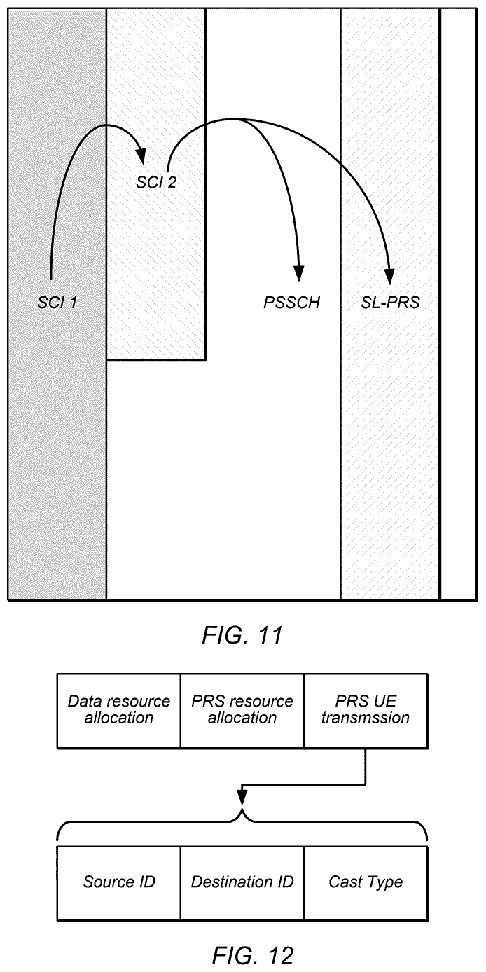

In some instances, for a shared resource pool, a two stage SCI may be used to reserve and/or indicate one or more sidelink PRS resources. In such instances, the second stage SCI may indicate the SL-PRS specific information to enable backwards compatibility with existing designs. In such instances, a stage 1 SCI may be a legacy SCI that indicates a stage 2 SCI format associated with sidelink PRS (e.g., such as stage 2 SCI format 2X). Thus, the stage 1 SCI may indicate a stage 2 SCI format 2A, 2B, or 2C for decoding PSSCH and a stage 2 SCI format 2X for indicating sidelink PRS parameters, e.g., as shown in FIG. 11. In some instances, e.g., as shown in FIG. 12, a sidelink SCI for sidelink PRS may include a data resource allocation (e.g., time and frequency), a PRS resource allocation (e.g., time and frequency), and/or PRS UE transmission information (e.g., source ID, destination ID, cast type indicator).

In some instances, when a UE, such as UE 106, is in an exceptional resource pool, the UE may disable positioning until normal connection is re-established. In some instances, when a UE, such as UE 106, is in an exceptional resource pool, the UE may use a shared resource pool between PSSCH and sidelink PRS to support sidelink UE positioning. In such instances, UE positioning requirements may be relaxed.

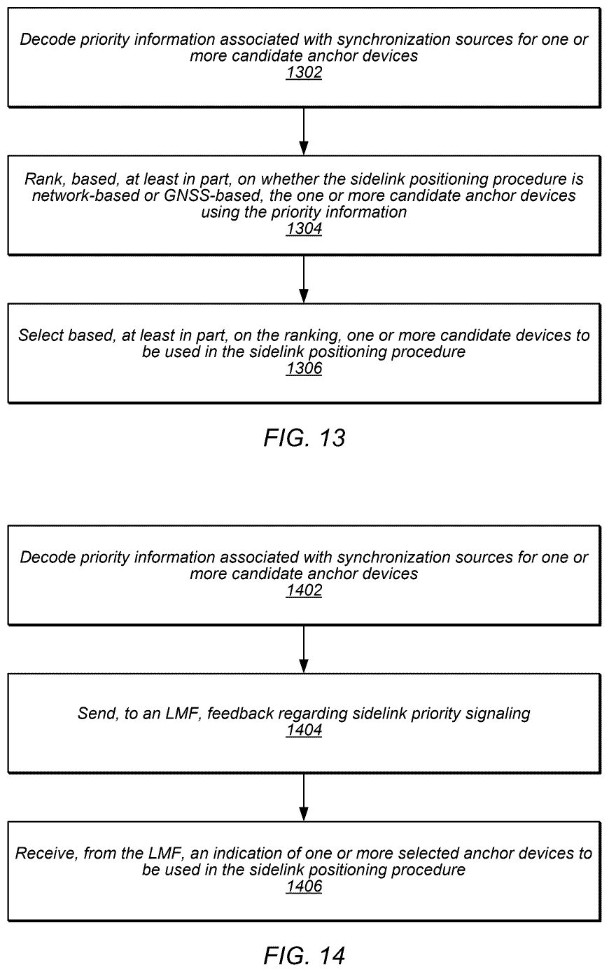

FIG. 13 illustrates a block diagram of an example of a method for selecting anchor devices for a sidelink positioning procedure, according to some embodiments. The method shown in FIG. 13 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1302, a UE, such as UE 106, may decode and/or determine priority information associated with synchronization sources for one or more candidate anchor devices.

At 1304, the UE may rank, prioritize, grade, order, classify, sort, arrange, organize, and/or categorize, based, at least in part, on whether the sidelink positioning procedure is network-based or Global Network Satellite System (GNSS) based, the one or more candidate anchor devices using the priority information. In some instances, to rank, prioritize, grade, order, classify, sort, arrange, organize, and/or categorize the one or more candidate anchor devices, the UE may rank, prioritize, grade, order, classify, sort, arrange, organize, and/or categorize the one or more candidate anchor devices based on a number of hops to a stable synchronization reference. In some instances, to rank, prioritize, grade, order, classify, sort, arrange, organize, and/or categorize the one or more candidate anchor devices, the UE may rank, prioritize, grade, order, classify, sort, arrange, organize, and/or categorize the one or more candidate anchor devices based on a preference for GNSS-based synchronization. In some instances, to rank, prioritize, grade, order, classify, sort, arrange, organize, and/or categorize the one or more candidate anchor devices, the UE may rank, prioritize, grade, order, classify, sort, arrange, organize, and/or categorize the one or more candidate anchor devices based on a preference for network-based synchronization.

At 1306, the UE may select, based, at least in part, on the ranking, prioritizing, grading, ordering, classifying, sorting, arranging, organizing, and/or categorizing, one or more candidate devices to be used in the sidelink positioning procedure. In some instances, to select the one or more candidate devices to be used in the sidelink positioning procedure, the UE may select the one or more candidate devices to be used in the sidelink positioning procedure based on a number of devices with a common synchronization reference. In some instances, to select the one or more candidate devices to be used in the sidelink positioning procedure, the UE may select one or more highest ranked, prioritized, graded, ordered, classified, sorted, arranged, organized, and/or categorized candidate devices to be used in the sidelink positioning procedure. For example, the UE may select the highest ranked, prioritized, graded, ordered, classified, sorted, arranged, organized, and/or categorized device (and/or set of devices) from devices A, B, C, D, and so forth.

In some instances, the priority information may include a flag used to indicate an index of a level associated with a synchronization type, an in coverage/out of coverage flag, and/or a sidelink synchronization signal (SLSS) identifier (ID). The flag used to indicate the index of the level may be received by the UE as part of the positioning procedure.

In some instances, the priority information may be included in a single stage sidelink control information (SCI), in a second stage SCI, in a PC5 radio resource control (RRC) message, or as part of positioning protocol assistance information in one of an LTE positioning protocol (LPP) message, an NR positioning protocol A (NRPPa) message, and/or a sidelink positioning protocol (SL-PP) message.

The single stage SCI may indicate the priority information when the UE is assigned a dedicated resource pool for the sidelink positioning procedure. Additionally, the single stage SCI may include positioning SCI fields as indicators of the priority information. Further, the positioning SCI fields may include one or more of a field indicating priority of a sidelink positioning reference signal (PRS) transmission, a field indicating priority of a sidelink PRS synchronization, a frequency resource assignment in sub-channels, a time resource assignment, a resource reservation period, a shared/dedicated resource pool indicator, a source identifier (ID), a destination ID, and/or a cast type indicator.

In some instances, the second stage SCI may indicate the priority information when the UE is assigned a shared resource pool for the sidelink positioning procedure. In some instances, the second stage SCI may indicate the priority information when the UE is assigned a dedicated resource pool for the sidelink positioning procedure. The second stage SCI may include positioning SCI fields as indicators of the priority information. Additionally, the positioning SCI fields may include one or more of a data resource allocation, a PRS resource allocation, and/or PRS UE transmission information. Further, the PRS UE transmission information may include a source ID, a destination ID, and/or a cast type indicator.

In some instances, when the UE is in an exceptional resource pool, the UE may disable sidelink positioning until connection re-establishment. In some instances, when the UE is in an exceptional resource pool, the UE may use a shared resource pool between a physical sidelink shared channel (PSSCH) and a sidelink positioning reference signal (PRS) to support sidelink positioning until connection re-establishment. In such instances, sidelink positioning requirements for the UE may be relaxed while the UE is in the exceptional resource pool.

FIG. 14 illustrates a block diagram of another example of a method for selecting anchor devices for a sidelink positioning procedure, according to some embodiments. The method shown in FIG. 14 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1402, a UE, such as UE 106, may decode and/or determine priority information associated with synchronization sources for one or more candidate anchor devices.

At 1404, the UE may send, to a location management function (LMF), such as LMF 609, feedback regarding sidelink priority signaling, e.g., as assistance information.

At 1406, the UE may receive, from the LMF, an indication of one or more selected anchor devices to be used in the sidelink positioning procedure. In some instances, the one or more selected anchor devices may be selected, based, at least in part, on whether the sidelink positioning procedure is network-based or GNSS-based.

In some instances, the priority information may include a flag used to indicate an index of a level associated with a synchronization type, an in coverage/out of coverage flag, and/or a sidelink synchronization signal (SLSS) identifier (ID). The flag used to indicate the index of the level may be received by the UE as part of the positioning procedure.

In some instances, the priority information may be included in a single stage sidelink control information (SCI), in a second stage SCI, in a PC5 radio resource control (RRC) message, or as part of positioning protocol assistance information in one of an LTE positioning protocol (LPP) message, an NR positioning protocol A (NRPPa) message, and/or a sidelink positioning protocol (SL-PP) message.

The single stage SCI may indicate the priority information when the UE is assigned a dedicated resource pool for the sidelink positioning procedure. Additionally, the single stage SCI may include positioning SCI fields as indicators of the priority information. Further, the positioning SCI fields may include one or more of a field indicating priority of a sidelink positioning reference signal (PRS) transmission, a field indicating priority of a sidelink PRS synchronization, a frequency resource assignment in sub-channels, a time resource assignment, a resource reservation period, a shared/dedicated resource pool indicator, a source identifier (ID), a destination ID, and/or a cast type indicator.

In some instances, the second stage SCI may indicate the priority information when the UE is assigned a shared resource pool for the sidelink positioning procedure. In some instances, the second stage SCI may indicate the priority information when the UE is assigned a dedicated resource pool for the sidelink positioning procedure. The second stage SCI may include positioning SCI fields as indicators of the priority information. Additionally, the positioning SCI fields may include one or more of a data resource allocation, a PRS resource allocation, and/or PRS UE transmission information. Further, the PRS UE transmission information may include a source ID, a destination ID, and/or a cast type indicator.

In some instances, when the UE is in an exceptional resource pool, the UE may disable sidelink positioning until connection re-establishment. In some instances, when the UE is in an exceptional resource pool, the UE may use a shared resource pool between a physical sidelink shared channel (PSSCH) and a sidelink positioning reference signal (PRS) to support sidelink positioning until connection re-establishment. In such instances, sidelink positioning requirements for the UE may be relaxed while the UE is in the exceptional resource pool.

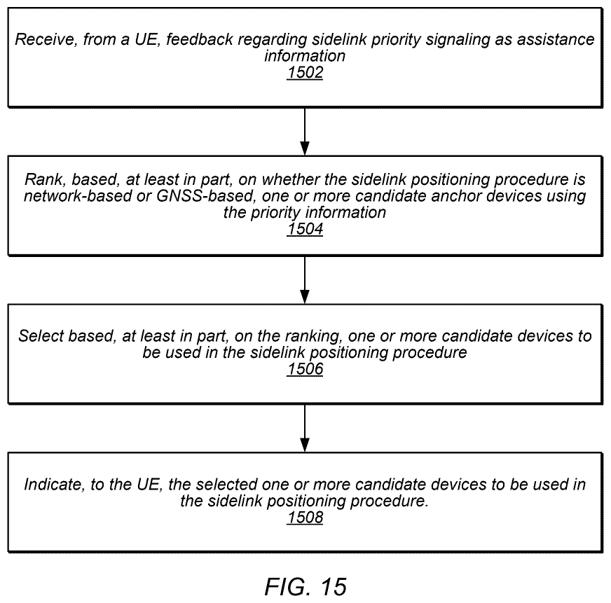

FIG. 15 illustrates a block diagram of a further example of a method for selecting anchor devices for a sidelink positioning procedure, according to some embodiments. The method shown in FIG. 15 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1502, a location management function (LMF), such as LMF 609, may receive, from a UE, such as UE 106, feedback regarding sidelink priority signaling, e.g., as assistance information.

At 1504, the LMF may rank, prioritize, grade, order, classify, sort, arrange, organize, and/or categorize, based, at least in part, on whether the sidelink positioning procedure is network-based or GNSS-based, one or more candidate anchor devices using the priority information. In some instances, to rank, prioritize, grade, order, classify, sort, arrange, organize, and/or categorize the one or more candidate anchor devices, the LMF may rank, prioritize, grade, order, classify, sort, arrange, organize, and/or categorize the one or more candidate anchor devices based on a number of hops to a stable synchronization reference. In some instances, to rank, prioritize, grade, order, classify, sort, arrange, organize, and/or categorize the one or more candidate anchor devices, the LMF may rank, prioritize, grade, order, classify, sort, arrange, organize, and/or categorize the one or more candidate anchor devices based on a preference for GNSS-based synchronization. In some instances, to rank, prioritize, grade, order, classify, sort, arrange, organize, and/or categorize the one or more candidate anchor devices, the LMF may rank, prioritize, grade, order, classify, sort, arrange, organize, and/or categorize the one or more candidate anchor devices based on a preference for network-based synchronization.

At 1506, the LMF may select based, at least in part, on the ranking, prioritizing, grading, ordering, classifying, sorting, arranging, organizing, and/or categorizing, one or more candidate devices to be used in the sidelink positioning procedure. In some instances, to select the one or more candidate devices to be used in the sidelink positioning procedure, the LMF may select the one or more candidate devices to be used in the sidelink positioning procedure based on a number of devices with a common synchronization reference. In some instances, to select the one or more candidate devices to be used in the sidelink positioning procedure, the LMF may select one or more highest ranked, prioritized, graded, ordered, classified, sorted, arranged, organized, and/or categorized candidate devices to be used in the sidelink positioning procedure. For example, the LMF may select the highest ranked, prioritized, graded, ordered, classified, sorted, arranged, organized, and/or categorized device (and/or set of devices) from devices A, B, C, D, and so forth.

At 1508, the LMF may indicate, to the UE, the selected one or more candidate devices to be used in the sidelink positioning procedure.

In some instances, the feedback may include priority information. The priority information may be included in a single stage sidelink control information (SCI), in a second stage SCI, in a PC5 radio resource control (RRC) message, or as part of positioning protocol assistance information in one of an LTE positioning protocol (LPP) message, an NR positioning protocol A (NRPPa) message, and/or a sidelink positioning protocol (SL-PP) message.

The single stage SCI may indicate the priority information when the UE is assigned a dedicated resource pool for the sidelink positioning procedure. Additionally, the single stage SCI may include positioning SCI fields as indicators of the priority information. Further, the positioning SCI fields may include one or more of a field indicating priority of a sidelink positioning reference signal (PRS) transmission, a field indicating priority of a sidelink PRS synchronization, a frequency resource assignment in sub-channels, a time resource assignment, a resource reservation period, a shared/dedicated resource pool indicator, a source identifier (ID), a destination ID, and/or a cast type indicator.

In some instances, the second stage SCI may indicate the priority information when the UE is assigned a shared resource pool for the sidelink positioning procedure. In some instances, the second stage SCI may indicate the priority information when the UE is assigned a dedicated resource pool for the sidelink positioning procedure. The second stage SCI may include positioning SCI fields as indicators of the priority information. Additionally, the positioning SCI fields may include one or more of a data resource allocation, a PRS resource allocation, and/or PRS UE transmission information. Further, the PRS UE transmission information may include a source ID, a destination ID, and/or a cast type indicator.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for selecting anchor devices for a sidelink positioning procedure, comprising:
a user equipment device (UE),
determining priority information associated with synchronization sources for one or more candidate anchor devices;
ranking, based, at least in part, on whether the sidelink positioning procedure is network-based or Global Network Satellite System (GNSS) based, the one or more candidate anchor devices using the priority information; and
selecting based, at least in part, on the ranking, one or more candidate devices to be used in the sidelink positioning procedure.

2. The method of claim 1,
wherein ranking the one or more candidate anchor devices comprises ranking the one or more candidate anchor devices based on:
a number of hops to a stable synchronization reference;
a preference for GNSS-based synchronization; or
a preference for network-based synchronization.

3. (canceled)

4. (canceled)

5. The method of claim 1,
wherein selecting the one or more candidate devices to be used in the sidelink positioning procedure comprises the UE selecting the one or more candidate devices to be used in the sidelink positioning procedure based on a number of devices with a common synchronization reference.

6. The method of claim 1,
wherein the priority information comprises a flag used to indicate an index of a level associated with a synchronization type, an in coverage/out of coverage flag, and a sidelink synchronization signal (SLSS) identifier (ID); and
wherein the flag used to indicate the index of the level is received by the UE as part of the positioning procedure.

7. (canceled)

8. The method of claim 1,
wherein the priority information is included in at least one of:
a single stage sidelink control information (SCI);
in a second stage SCI;
in a PC5 radio resource control (RRC) message; or
as part of positioning protocol assistance information in at least one of:
an LTE positioning protocol (LPP) message;
an NR positioning protocol A (NRPPa) message; or
a sidelink positioning protocol (SL-PP) message.

9. The method of claim 8,
wherein the single stage SCI indicates the priority information when the UE is assigned a dedicated resource pool for the sidelink positioning procedure and comprises positioning SCI fields as indicators of the priority information, wherein the positioning SCI fields include one or more of:
a field indicating priority of a sidelink positioning reference signal (PRS) transmission;
a field indicating priority of a sidelink PRS synchronization;
a frequency resource assignment in sub-channels;
a time resource assignment;
a resource reservation period;
a shared/dedicated resource pool indicator;
a source identifier (ID); a destination ID; or
a cast type indicator.

10. (canceled)

11. (canceled)

12. The method of claim 8,
wherein the second stage SCI indicates the priority information when the UE is assigned a shared resource pool or a dedicated resource pool for the sidelink positioning procedure and comprises positioning SCI fields as indicators of the priority information, wherein the positioning SCI fields comprise one or more of a data resource allocation, a PRS resource allocation, or PRS UE transmission information, and wherein the PRS UE transmission information comprises a source ID, a destination ID, and a cast type indicator.

13.-15. (canceled)

16. The method of claim 1,
wherein, when the UE is in an exceptional resource pool, the method further comprises the UE disabling sidelink positioning until connection re-establishment.

17. The method of claim 1,
wherein, when the UE is in an exceptional resource pool, the method further comprises the UE using a shared resource pool between a physical sidelink shared channel (PSSCH) and a sidelink positioning reference signal (PRS) to support sidelink positioning until connection re-establishment; and
wherein sidelink positioning requirements for the UE are relaxed while the UE is in the exceptional resource pool.

18.-20. (canceled)

21. A method for selecting anchor devices for a sidelink positioning procedure, comprising:
a location management function (LMF),
receiving, from a user equipment device, feedback regarding sidelink priority signaling as assistance information;
ranking, based, at least in part, on whether the sidelink positioning procedure is network-based or Global Network Satellite System (GNSS) based, one or more candidate anchor devices using the priority information;
selecting based, at least in part, on the ranking, one or more candidate devices to be used in the sidelink positioning procedure; and
indicating, to the UE, the selected one or more candidate devices to be used in the sidelink positioning procedure.

22. The method of claim 21,
wherein ranking the one or more candidate anchor devices comprises ranking one or more candidate anchor devices based on:
a number of hops to a stable synchronization reference;
a preference for GNSS-based synchronization; or
a preference for network-based synchronization.

23. (canceled)

24. (canceled)

25. The method of claim 21,
wherein selecting the one or more candidate devices to be used in the sidelink positioning procedure comprises the LMF selecting the one or more candidate devices to be used in the sidelink positioning procedure based on a number of devices with a common synchronization reference.

26. The method of claim 21,
wherein the feedback includes priority information that comprises a flag used to indicate an index of a level associated with a synchronization type, an in coverage/out of coverage flag, and a sidelink synchronization signal (SLSS) identifier (ID).

27. (canceled)

28. The method of claim 21,
wherein the priority information is included in at least one of:
a single stage sidelink control information (SCI);
in a second stage SCI;
in a PC5 radio resource control (RRC) message; or
as part of positioning protocol assistance information in at least one of:
an LTE positioning protocol (LPP) message;
an NR positioning protocol A (NRPPa) message; or
a sidelink positioning protocol (SL-PP) message.

29. The method of claim 28,
wherein the single stage SCI indicates the priority information when the UE is assigned a dedicated resource pool for the sidelink positioning procedure and comprises positioning SCI fields as indicators of the priority information, wherein the positioning SCI fields include one or more of:
a field indicating priority of a sidelink positioning reference signal (PRS) transmission;
a field indicating priority of a sidelink PRS synchronization;
a frequency resource assignment in sub-channels;
a time resource assignment;
a resource reservation period;
a shared/dedicated resource pool indicator;
a source identifier (ID); a destination ID; or
a cast type indicator.

30. (canceled)

31. (canceled)

32. The method of claim 28,
wherein the second stage SCI indicates the priority information when the UE is assigned a shared resource pool for the sidelink positioning procedure.

33. The method of claim 32,
wherein the second stage SCI comprises positioning SCI fields as indicators of the priority information; and
wherein the positioning SCI fields comprise one or more of a data resource allocation, a PRS resource allocation, or PRS UE transmission information.

34. (canceled)

35. The method of claim 33,
wherein the PRS UE transmission information comprises a source ID, a destination ID, and a cast type indicator.

36. An apparatus, comprising:
a memory; and
at least one processor in communication with the memory and configured to:
determine priority information associated with synchronization sources for one or more candidate anchor devices;
rank, based, at least in part, on whether the sidelink positioning procedure is network-based or Global Network Satellite System (GNSS) based, the one or more candidate anchor devices using the priority information; and
select based, at least in part, on the ranking, one or more candidate devices to be used in the sidelink positioning procedure.

37. The apparatus of claim 36,
wherein ranking the one or more candidate anchor devices comprises ranking the one or more candidate anchor devices based on:
a number of hops to a stable synchronization reference;
a preference for GNSS-based synchronization; or
a preference for network-based synchronization.
